(19) United States
(12) Patent Application Publication
(10) Pub. No.: US 2009/0315881 A1
(43) Pub. Date: Dec. 24, 2009

(54) DISPLAY PROCESSING DEVICE, DISPLAY PROCESSING METHOD, AND DISPLAY PROCESSING PROGRAM

(75) Inventors: Reiji Matsumoto, Saitama (JP); Hajime Adachi, Saitama (JP); Kazuo Murata, Saitama (JP); Yuya Kawagishi, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/295,547

(22) PCT Filed: Mar. 30, 2007
(86) PCT No.: PCT/JP2007/057115

§ 371 Date: Nov. 13, 2008

(30) Foreign Application Priority Data
Mar. 31, 2006 (JP) 2006-099052

(51) Int. Cl. G06T 1/00

(52) U.S. Cl. 345/418

(57) ABSTRACT

In case it is necessary to have high-speed drawing processing such as display scrolling and so on, a drawing switching signal is input at a step, and high-speed drawing display data is output to a display at a step in response to this input, thereby display is performed. A high-speed drawing data generating means generates high-speed drawing display data for displaying each pixel concerning a character or visual object using a digitized gradation value digitized from each corresponding gradation value, and display is performed on this generated data. When it is necessary to have high-speed drawing, it is possible to have quick processing without increasing loads on a CPU and graphic controller on digitized data from gradation value.

### CROSS-REFERENCE TO RELATED APPLICATION

This application is based on Japanese Patent Application No. 2006-099052 filed on Mar. 31, 2006, the contents of which is incorporated hereinto by reference.

### BACKGROUND OF THE INVENTION

1. Field of the Invention

The present invention relates to a display processing apparatus, a display processing method, and a display processing program on a navigation apparatus and the like.

2. Description of the Related Art

On navigation apparatus and so on, characters in geographic names and so on included in map screens, character strings as options included in menu screens, or character strings as other descriptive texts are drawn on font data provided in the apparatus. In particular, in recent navigation apparatus it tends to be demanded to perform highly fine display processing. It is demanded to enable to improve character expressiveness or use characters in various sizes.

However, when an operation such as scrolling in a screen is performed by an operator in a state such a display processing is carried out, high-speed drawing is needed in correspond to this operation. A method to perform special drawing processing while such a scrolling is shown in, for instance, JP, A, 2000-241176 and JP, A, 9-292258.

The prior art anticipated in JP, A, 2000-241176 shows a technology that roads and names should be displayed are dynamically increased or decreased based on whether an amount of displaying data exceeds a predetermined value or not. Concretely, in the prior art, while scrolling and the like an amount of drawn items is decreased, thereby, it is assured to display routes or roads around a car driven by a driver at least.

The prior art anticipated in JP, A, 9-292258 shows a technology to restrict drawing shape of houses under a specific condition on a guide apparatus that displays maps of shape of buildings. Concretely, by setting a display color of shape of houses to the same color as a background color (or not drawing shape of houses) while scrolling and the like, the prior art prevents screens from being indistinct even while scrolling and provides necessary information.

On a display screen through digital processing there is a case that a phenomenon (jaggy), in which a curve or an oblique straight line becomes jaggy like stairs, occurs when a picture or character drawn with dots is zoomed. In recent years, in order to eliminate this jaggy, in case displaying, for instance, a black character in a white background, a method (=anti-aliasing) making jaggy less noticeable using gray as an intermediate gradation (=a gray scale) has been used gradually. When applying this anti-aliasing to the above explained navigation apparatus, a gray value for each pixel is determined as blend ratio to have blend-drawing in relation to a gray scale in characters and so on drawn on a map.

Here, although a graphic controller used in, e.g., navigation apparatus includes a function that performs blend-drawing a bitmap of 1-bpp at high speed (a pixel “1” is subjected to blend-drawing, and a pixel “2” is drawn at blend ratio 0, i.e., as it is), a graphic controller, which cannot have blend-drawing at blend ratio in accordance with each pixel, is popular. Therefore, while blend-drawing with the gray scale, character data of the gray scale is decomposed into pieces of 1-bpp bitmap data corresponding to the gray scale formed of pixels at common blend ratio alone, and blend-drawing is carried out for the same times as the number of the decomposed pieces. As a result, the number of gradations in the gray scale greatly affects performance of drawing, loads on a CPU and the graphic controller are extremely increased while high-speed drawing like scrolling is necessary in particular.

In the prior art anticipated in JP, A, 2000-241176 or JP, A, 9-292258, high-speed drawing in display processing including characters of the above-described gray scale is not considered in particular, and the prior art cannot be applied as it is. Especially, because the prior art anticipated in JP, A, 2000-241176 sets a state in where characters are not perfectly drawn while scrolling, deleted character information completely lacks.

The above described problem is given as one of examples the present invention should solve.

### SUMMARY OF THE INVENTION

To solve the problem, the invention according to claim 1 is a display processing apparatus generates and outputs display data for displaying a character or visual object (a symbol mark, a sign, and the like) that consists of a plurality of pixels on a display means using a predetermined gradation value in accordance with each pixel, comprising: a drawing switching signal input means that inputs a drawing switching signal for shift to high-speed drawing processing; a high-speed drawing data generating means that generates high-speed drawing display data for displaying each pixel concerning the character or visual object on the display means using a digitized gradation value digitized from the corresponding gradation value; and a high-speed drawing data output means that outputs the high-speed drawing display data generated by the high-speed drawing data generating means to the display means when the drawing switching signal is input by the drawing switching signal input means.

To solve the above described problem, the invention according to claim 9 is a display processing method for generating and outputting display data for displaying a character or visual object that consists of a plurality of pixels on a display means using a predetermined gradation value in accordance with each pixel, comprising: inputting a drawing switching signal for shift to high-speed drawing processing; generating high-speed drawing display data for displaying each pixel concerning the character or visual object on the display means using a digitized gradation value digitized from the corresponding gradation value; and outputting the generated high-speed drawing display data to the display means when the drawing switching signal is input.

To solve the above described problem, the invention according to claim 10 allows a computation means provided in a display processing apparatus to execute: inputting a drawing switching signal for shift to high-speed drawing processing, generating high-speed drawing display data for displaying each pixel concerning the character or visual object on the display means using a digitized gradation value digitized from the corresponding gradation value; and outputting the generated high-speed drawing display data to the display means when the drawing switching signal is input.

### BRIEF DESCRIPTION OF THE DRAWINGS

FIG. 1 is a block diagram showing an entire functional structure of a car navigation apparatus having a display processing apparatus according to a first embodiment of the present invention;

FIG. 2 is an explanatory drawing showing an example of anti-aliasing that makes jaggy less noticeable;

FIG. 3 is an explanatory drawing showing an example where a structure shown in FIG. 2 is superimposed on a map to be displayed;

FIG. 4 is an explanatory drawing showing an example of a gradation value distribution for each pixel in font data;

FIG. 5 is an explanatory drawing showing behaviors in high-speed drawing processing;

FIG. 6 is a flowchart showing a control procedure executed by a graphic controller;

FIG. 7 is an explanatory drawing showing data when decomposed and generated into 1-bpp bitmap data in accordance with each gradation value while regular drawing;

FIG. 8 is an explanatory drawing showing blend-drawing behaviors while regular drawing;

FIG. 9 is an explanatory drawing showing a technique of creating predetermined pre-rasterized bitmap data from each gradation 1-bpp bitmap data in advance in a display processing apparatus according to the second embodiment of the present invention;

FIG. 10 is a flowchart showing a control procedure executed by a graphic controller;

FIG. 11 is an explanatory drawing showing a technique of creating predetermined pre-rasterized bitmap data from each gradation 1-bpp bitmap data in advance in a display processing apparatus according to a third embodiment of the present invention;

FIG. 12 is a flowchart showing a control procedure executed by a graphic controller; and

FIG. 13 is an explanatory drawing showing blend-drawing behaviors while regular drawing.

### DETAILED DESCRIPTION OF THE PREFERRED EMBODIMENTS

The following describes an embodiment of the present invention with reference to accompanying drawings.

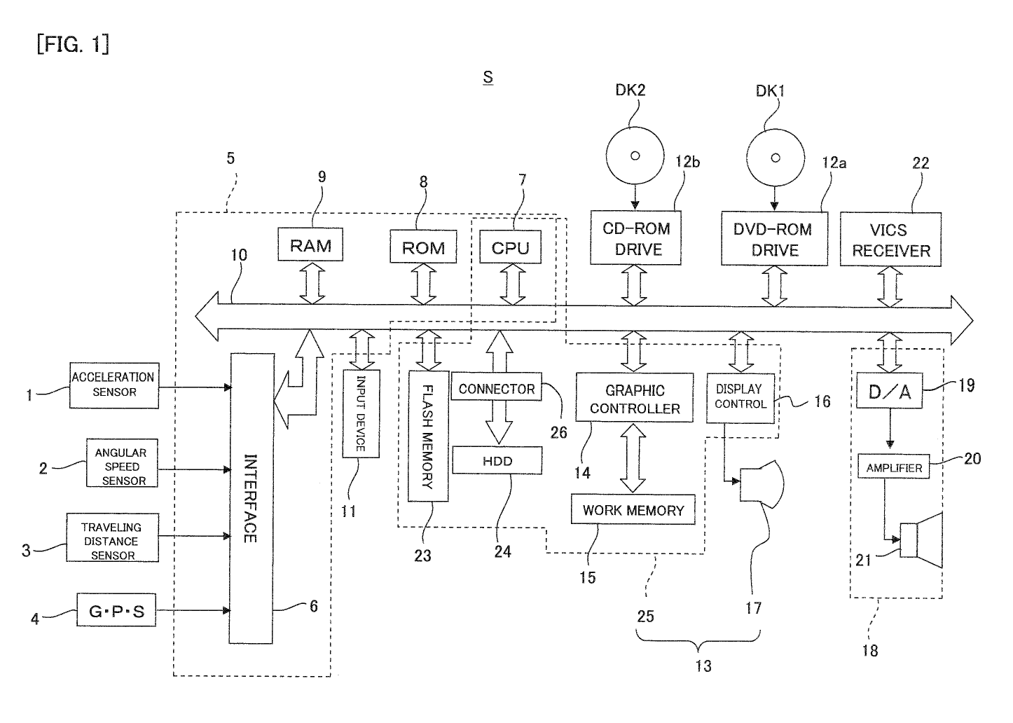

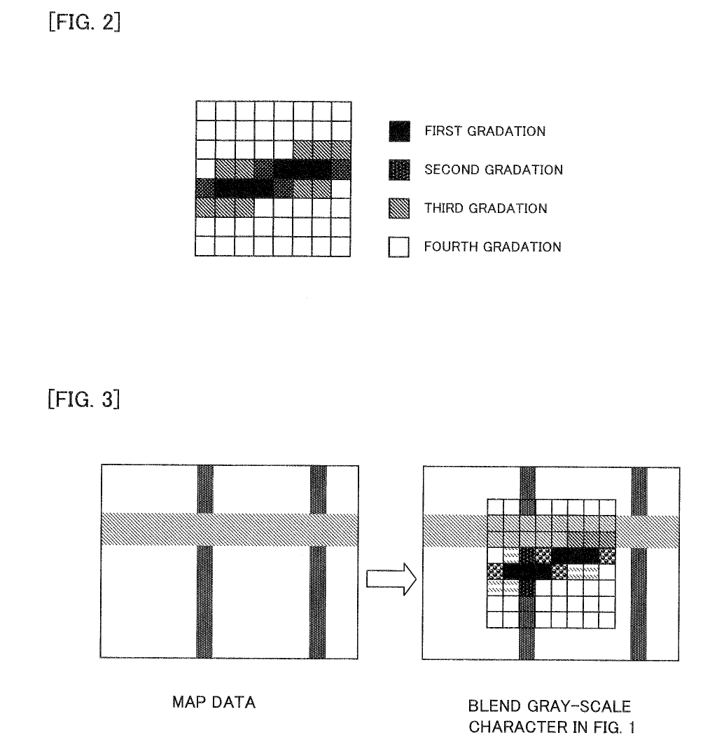

A first embodiment of the present invention will be explained with reference to FIGS. 1 to 7. The present embodiment is an embodiment when using data formed of a gradation value (blend ratio) of each pixel as font data.

FIG. 1 is a block diagram showing an entire functional structure of a car navigation apparatus having a display processing apparatus according to the present embodiment.

In FIG. 1, a car navigation apparatus S includes: an acceleration sensor 1 that detects an acceleration in a traveling direction actually applied to a vehicle when a car starts moving, stops, accelerates, or decelerates, and outputs acceleration data; an angular speed sensor 2 that detects an angular speed when the car rotates, and outputs angular speed data and relative bearing data; a traveling distance sensor 3 that detects a vehicle speed pulse signal associated with rotation of wheels; and a GPS receiver 4 that receives radio waves from GPS (Global Positioning System) satellites, outputs GPS positioning data such as latitude and longitude and so on at which the car is positioned, and outputs absolute direction data on a traveling direction of the car. Here, as examples of the acceleration sensor 1, it is possible to list various styles: a semiconductor acceleration sensor such as an capacitance type or a piezo type, and an acceleration sensor such as a piezoelectric element type.

Further, the navigation apparatus S includes: a system controller 5 that controls the entire navigation system based on acceleration data, relative bearing data, angular speed data, traveling distance data, GPS positioning data, and absolute direction data respectively output from the acceleration sensor 1, the angular speed sensor 2, the traveling distance sensor 3, and the GPS receiver 4; an input device 11 that includes appropriate operating means such as a touch panel, keys, switches, buttons, and a remote controller through which an operator inputs various kinds of operations; a hard disk drive 24, a flash memory 23, a DVD-ROM drive 12a, and a CD-ROM drive 12b which read out various kinds of data, e.g., map data including road data indicative of the number of lanes or a road width or data indicative of detailed information of each facility from at least one of the hard disk drive 24, the flash memory 23, a DVD-ROM (DVD Read Only Memory) disk DK1, and a CD-ROM (Compact Disk Read Only Memory) disk DK2 and output the read data; a display unit 13 that displays various kinds of display data under control of the system controller 5; an acoustic regeneration unit 18 that plays and outputs various kinds of sound data under control of the system controller 5; and a VICS receiver 22 that receives traffic information based on a VICS (Vehicle Information and Communication System).

The system controller 5 includes: an interface part 6 that performs an interface operation to an external sensor such as the GPS receiver 4; a CPU 7, which calculate a traveling distance of the car by measuring number of pulses on a vehicle speed pulse signal from the traveling distance sensor 3, and controls the entire system controller 5; a ROM (Read Only Memory) 8 that stores, e.g., a control program for controlling the system controller 5; and a readable/writable RAM (Random Access Memory) 9 that stores various kinds of data, e.g., route data preset by a user through the input device 11. The system controller 5 is connected to the input device 11, the hard disk drive 24, the flash memory 23, the DVD-ROM drive 12a, the CD-ROM drive 12b, the display unit 13, the acoustic regeneration unit 18, and the VICS receiver 22 via a bus line 10.

The display unit 13 has a display 17 (displaying means) such as an LCD device or a CRT display device and a display processing apparatus 25 according to the present embodiment that generates and outputs display data for displaying characters or visual objects in this display 17. The display processing apparatus 25 is formed of the CPU 17, a graphic controller 14 that controls the entire display unit 13 based on control data supplied from the CPU 7 through the bus line 10, a work memory 15 that consists of a memory such as a VRAM (Video RAM) and temporarily stores and holds image information of, e.g., characters of visual objects so as to be read or written without restraint, the display control part 16 that controls display in the display 17 based on image data output from the graphic controller 14, the flash memory 23 that stores scalable font data concerning characters or visual objects, the hard disk drive 24 including a hard disk (not shown) storing pre-rasterized bitmap font data concerning characters or visual objects, and others. On a side note, the hard disk drive 24, in this example, is installed in the display processing apparatus 25 (the graphic controller 14) via a connector 26 in an attachable and detachable manner. Also, the work memory 15 is, as explained above, not only connected with the graphic controller 14, but also provided as a predetermined region in a memory connected with the CPU of the graphic controller 14 (an unified architecture).

The acoustic regeneration unit 18 includes a D/A converter 19 that performs D/A conversion on sound digital data supplied from at least one of the hard disk drive 24, the flash memory 23, the DVD-ROM drive 12a, the CD-ROM drive 12b, and the RAM 9 via the bus line 10, an amplifier 20 that amplifies a sound analog signal output from the D/A converter 19, and a speaker 21 that converts the amplified sound analog signal into sound to be output to the outside.

In this example, the flash memory 23 stores a plurality of pieces of scalable font data SCD concerning a character or visual object. This scalable font data represents a locus of a character in the form of a vector, and is font data that can represent a character in an arbitrary character size. On a side note, the flash memory is used as a preferred storage medium that stores the scalable font data in the above example, however the present embodiment is not limited thereto, for instance, an external storage device such as a hard disk drive or a DVD-ROM drive may store the scalable font data.

In this example, the hard disk drive 24 (to be exact, this is a non-illustrated hard disk included in the hard disk drive 24. This will be referred to as an HDD 24 hereinafter) stores a plurality of pieces of pre-rasterized bitmap font data BMP concerning characters or visual objects. This pre-rasterized bitmap font data means font data obtained by spreading scalable font data to a desired size to be provided as bitmap data in advance. The HDD 24 stores a plurality of pieces of pre-rasterized bitmap font data BMP concerning desired characters. On a side note, as explained above, the HDD 24 is connected to the graphic controller 14 via the connector 26 in an attachable and detachable manner.

On a side note, the HDD is used as a preferred storage medium that stores the pre-rasterized bitmap font data in the above example, however the present embodiment is not restricted thereto, and an external storage device such as a flash memory or a DVD-ROM drive may store the pre-rasterized bitmap font data.

The work memory 15 is a working memory that temporarily stores and holds character data such as the scalable font data SCD read out from the flash memory 23, the pre-rasterized bitmap font data BMP read out from the HDD 24, image information of visual objects such as a map and so on in a readable and writable manner. This work memory 15 has a scalable font area 15A, in which the scalable font data SCD regularly stays (this means that data read out from the flash memory 23 and so on is copied and temporarily stored in the work memory 15. This can be likewise applied to the following examples), and a pre-rasterized bitmap font area 15B, on which the pre-rasterized bitmap font data BMP read out from the HDD 24 regularly stays.

The graphic controller 14 executes drawing processing of font data corresponding to a character as a display target by mainly using the pre-rasterized bitmap font data MBP that regularly stays in the pre-rasterized bitmap font area 15B in the work memory 15. In further detail, the graphic controller 14 has a function of performing blend-drawing with respect to a bitmap of 1 bpp in, e.g., a frame buffer in the work memory 15.

### (A) Basic Principle as Background of the Present Embodiment

A basic principle as a background of the present embodiment will be explained with reference to FIGS. 2 and 3. On a display screen based on digital processing, a phenomenon (jaggy), in which a curve or an oblique straight line becomes jaggy like stairs when a picture or character drawn using dots is zoomed, occurs in some cases. In order to eliminate this jaggy, it is possible to use a method (=anti-aliasing) that also utilizes gray as an intermediate gradation when displaying, e.g., a black character in a white background to make the jaggy less noticeable. FIG. 2 is an explanatory drawing showing an example of this technique, and a second gradation and a third gradation as intermediate colors are provided (to lighten colors in the mentioned order) between a first gradation and a fourth gradation as a background color in order to eliminate (reduce) jaggy of a basic graphic form caused due to the first gradation in this example, thereby realizing a gray scale using a total of four gradations. In the present embodiment, fixed size font data of the gray scale (or pre-rasterized data in a scalable font) is stored as data formed of a gradation value (blend ratio) for each pixel in the flash memory 23 or the HDD 24. Moreover, the drawing processing is executed by reading out such data using the graphic controller 14 and providing a copy of this data in the work memory 15.

FIG. 3 is an explanatory drawing showing a case where the structure shown in FIG. 2 is superimposed on a map to be displayed as an example when the anti-aliasing is applied to the navigation apparatus. In this case, blend-drawing is carried out with a gray value for each pixel being determined as blend ratio in regard to the gray scale in characters and so on which are drawn on a map.

### (B) Basic Behaviors in the Present Embodiment

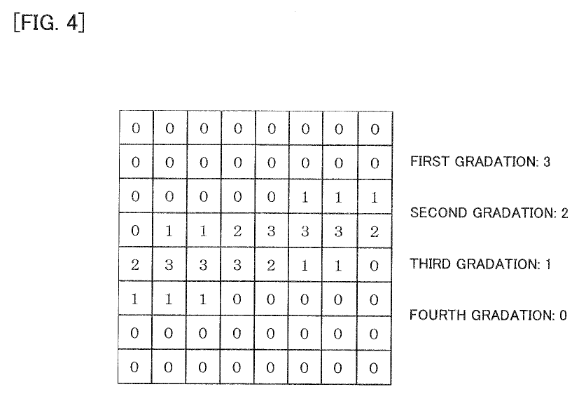

In the present embodiment, data formed of a gradation value (blend ratio) for each pixel is used as font data of a character or visual object as explained above. FIG. 4 is an explanatory drawing showing an example of a gradation value distribution for each pixel in the font data. FIG. 4 shows data that consists of 8×8=64 pixels of the first to fourth gradations shown in FIG. 2 as an example, and a gradation value “3” denotes the first gradation; a gradation value “2”, the second gradation; a gradation value “1”, the third gradation; and a gradation value “0”, the fourth gradation in the drawing (a color becomes darker as the gradation value is increased).

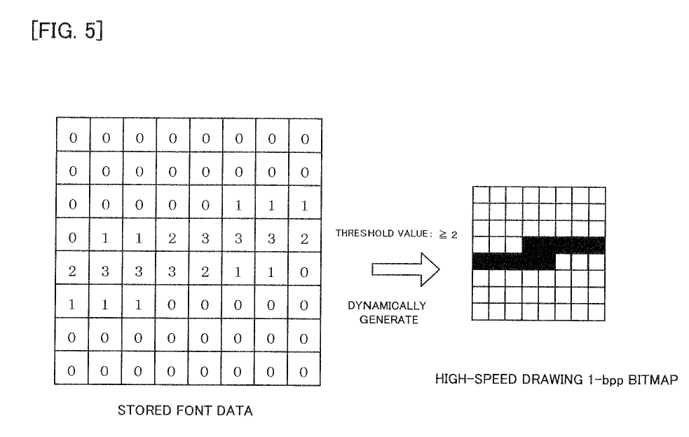

Additionally, in the present embodiment, processing of reducing the gradation number (digitization) is executed to reduce a load imposed on the graphic controller 14 while high-speed drawing such as scrolling. That is, as shown in FIG. 5, a threshold value (2 in this example) is provided for the gradation values, and 1-bpp bitmap data that consists of pixels equal to above this threshold value alone is dynamically generated to execute drawing while high-speed drawing. On a side note, by setting a boundary using a power of 2 enables executing drawing processing at high speed in this example.

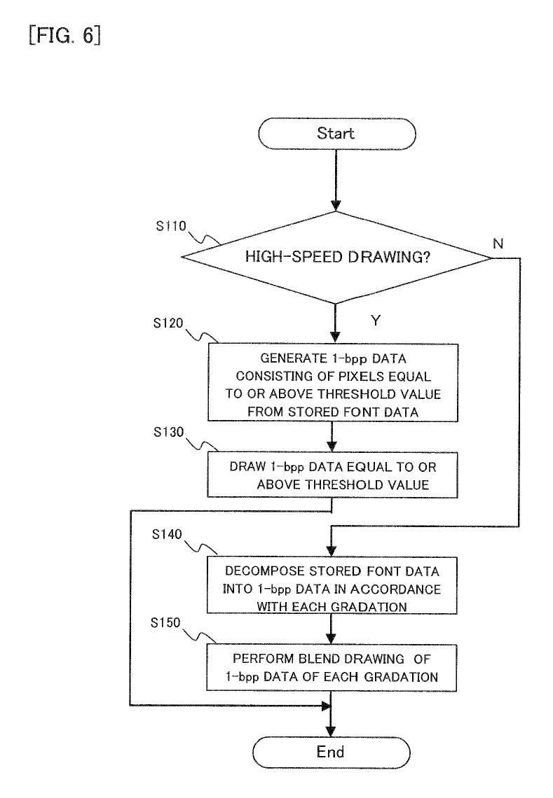

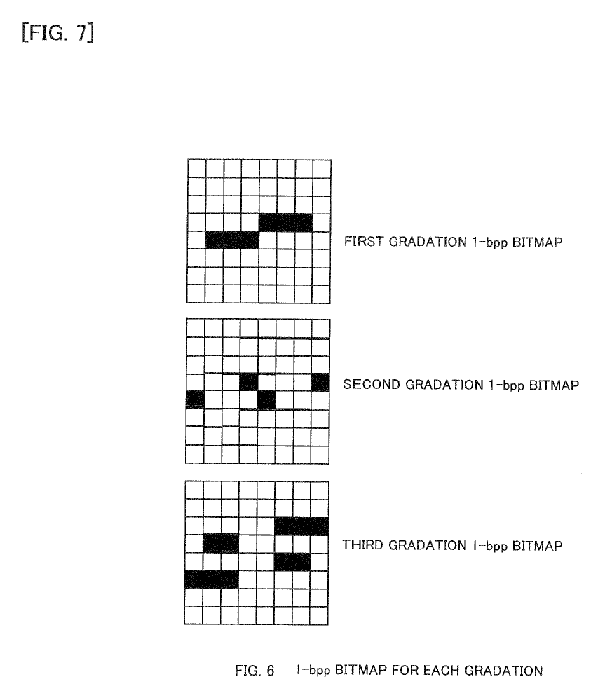

FIG. 6 is a flowchart showing a control procedure for drawing one unit, e.g., one character which is executed by the graphic controller 14 to carry out the drawing processing explained in conjunction with FIG. 5. On a side note, this flowchart is started when, e.g., the car navigation apparatus S is activated.

In FIG. 6, at first, in step S110, scrolling and the like are executed through an operation by an operating means, and a determination is made upon whether a drawing switching signal for shift to high-speed drawing from regular drawing is input (whether a current mode is a high-speed drawing mode) from the system controller 5 in accordance with scrolling and others.

The determination is satisfied if the drawing switching signal is input, and the processing advances to step S120. In the step S120, 1-bpp bitmap data in which pixels equal to or above the predetermined threshold value (the gradation value=2 in the example shown in FIG. 5) are extracted is generated from drawing target font data (e.g., such a conformation as shown in FIG. 4) stored in the work memory 15 at this point in time as explained above with reference to FIG. 5.

Afterwards, in step S130, the 1-bpp bitmap data generated in the step S120 is output to the display 17 through the display control part 16 to execute drawing, and this flow is terminated.

On the other hand, if the drawing switching signal for shift to high-speed drawing from regular drawing is not input in the step S110, the determination is not satisfied, and the processing proceeds to step S140.

In this situation, although the graphic controller 14 according to the present embodiment has a function of performing blend-drawing of bitmap data of 1 bpp at high speed like a mainstream of general navigation apparatuses, a case where the graphic controller 14 cannot execute blend-drawing having blend ratio for each pixel is assumed. Then, at this step S140, drawing target font data (such a conformation as shown in FIG. 4) stored in the work memory 15 at this point in time is decomposed into 1-bpp bitmap data for each pixel having a common (the same) gradation value.

In this example, since the four types of gradation values 0 to 3 are present as explained above with reference to FIGS. 4 and 5, the font data is decomposed into and generated as three pieces of data, i.e., 1-bpp bitmap data including pixels of the first gradation having the gradation value 3, 1-bpp bitmap data including pixels of the second gradation having the gradation value 2, and 1-bpp bitmap data including pixels of the third gradation having the gradation value 1. Since pixels of the fourth gradation having the gradation value 0 are not drawn at all, 1-bpp bitmap data is not required for these pixels. FIG. 7 is an explanatory drawing showing data of the first gradation (the gradation value 3), data of the second gradation (the gradation value 2), and data of the third gradation (the gradation value 1) at this moment.

Afterwards, moving to step S150, the 1-bpp bitmap data of each gradation generated in the step S140 is multiplied by a desired blend ratio to provide gray-scale data, this data is output to the display 17 through the display control part 16 to effect drawing, and this flow is terminated.

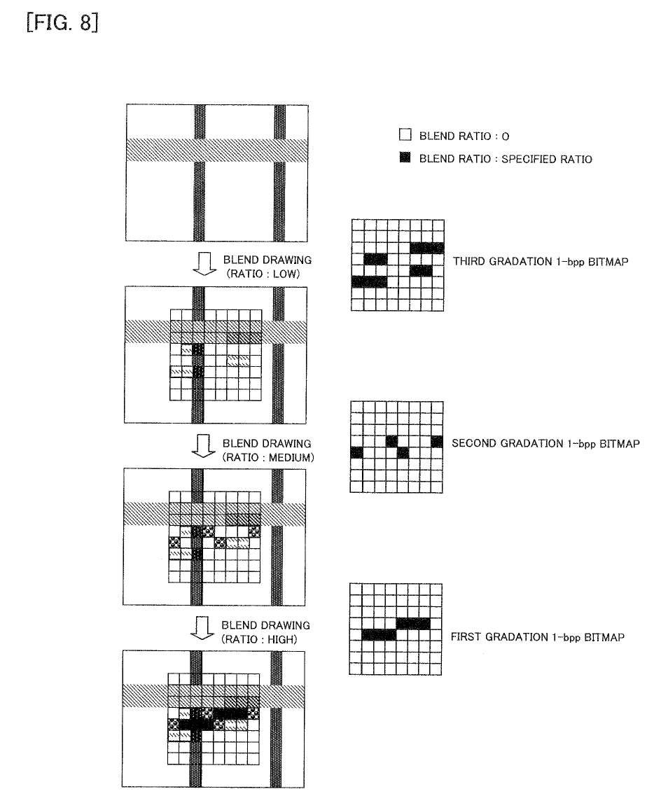

FIG. 8 is an explanatory drawing showing behaviors at this moment, the third gradation 1-bpp bitmap data having the lowest blend ratio (the gradation value 1) is blend-drawn on a map, the second gradation 1-bpp bitmap data having a medium blend ratio (the gradation value 2) is blend-drawn on the same, and the first gradation 1-bpp bitmap data having the highest blend ratio (the gradation value 3) is blend-drawn on the same.

When the step 150 is finished, this flow is terminated.

As explained above, the display processing apparatus 25 according to the present embodiment is the display processing apparatus 25 which generates and outputs display data for displaying a character or visual object that consists of a plurality of pixels on the display means (the display 17 in this example) using a predetermined gradation value in accordance with each pixel, and it is characterized by comprising: a drawing switching signal input means (the step S110 in the flow shown in FIG. 6 in this example) that inputs a drawing switching signal for shift to high-speed drawing processing; a high-speed drawing data generating means (the step S120 in the flow shown in FIG. 6 in this example) that generates high-speed drawing display data for displaying each pixel concerning the character or visual object on the display means 17 using a digitized gradation value digitized from a corresponding gradation value; and a high-speed drawing data output means (the step S130 in the flow shown in FIG. 6 in this example) that outputs the high-speed drawing display data generated by the high-speed drawing data generating means S120 to the display means 17 when the drawing switching signal is input by the drawing switching signal input means S110.

In the display processing apparatus 25 according to the present embodiment, in case high-speed drawing processing such as display scrolling and the like needed to be performed on the display means 17, the drawing switching signal is input by the drawing switching signal input means S110. In response to this input, the high-speed drawing display data is output to the display means 17 from the high-speed drawing data output means S130, and display is performed. While this high-speed drawing is performed, in case a plurality of pieces of gradation value specific drawing display data that consists of pixels with a common gradation value are used, computations for drawing processing are increased as the number of the gradation values rises. Therefore, a load on the graphic controller for drawing is increased. In the present embodiment, the high-speed drawing data generating means S120 generates the high-speed drawing display data for displaying each pixel concerning a character or visual object in the form of a digitized gradation value digitized from a corresponding gradation value, and display is performed on the display means 17 using this generated data.

As explained above, when high-speed drawing is required, using data digitized from each gradation value (in other words, data having the reduced number of gradations) enables executing rapid processing without increasing a load imposed on the graphic controller. Further, while scrolling and the like requiring high-speed drawing, visibility is low from the beginning. Therefore, even if each gradation value is reduced to slightly decrease a quality of a character of a visual object, a reduction in visual effect such as appearances or definiteness can be suppressed at minimum.

As explained above, even in high-speed drawing of display data having the plurality of gradation values, e.g., a gray scale, rapid drawing processing can be executed while hardly reducing the visual effect.

A display processing method carried out on the display processing apparatus 25 according to the present embodiment is a display processing method of generating and outputting display data for displaying a character or visual object that consists of a plurality of pixels on the display means 17 using a predetermined gradation value in accordance with each pixel; wherein: inputting a drawing switching signal for shift to high-speed drawing; generating high-speed drawing display data for displaying each pixel concerning a character or visual object on the display means 17 using a digitized gradation value digitized from a corresponding gradation value; and outputting the generated high-speed drawing display data to the display means 17 when the drawing switching signal is input.

In the display processing method according to the present embodiment, in case high-speed drawing processing such as display scrolling on the display means 17 needs to be performed, the drawing switching signal is input. In response to this input, the high-speed drawing display data is output to the display means 17, and display is performed.

When this high-speed drawing is performed, in case a plurality of pieces of gradation value specific drawing display data, which consists of pixels with a common gradation value, are used, computations for drawing processing are increased as the number of the gradation values rises. Therefore, loads on the CPU and the graphic controller for drawing are increased. In the present embodiment, the high-speed drawing display data for displaying each pixel concerning a character or visual object using a digitized gradation value digitized from a corresponding digitized value is generated, and this generated data is used to display on the display means 17.

When the high-speed drawing is required like this situation, using data digitized from each gradation value (in other words, data having the reduced number of gradation values) enables executing rapid processing without increasing loads on the CPU and the graphic controller. Also, while scrolling and the like requiring the high-speed drawing, visibility has been low from the beginning. Therefore, even if each gradation value is reduced and a quality of a character or visual object is thereby lightly decreased, a reduction in visual effect such as appearances or definiteness can be restrained at minimum.

As explained above, while the high-speed drawing of display data having the plurality of gradation values such as a gray scale, rapid drawing processing can be executed while hardly reducing the visual effect.

A display processing program which carries out the display processing method according to the present embodiment is characterized by allowing a computation means (the CPU 7 in this example) provided in the display processing apparatus 25 to execute: inputting a drawing switching signal for shift to high-speed drawing; generating high-speed drawing display data for displaying each pixel concerning a character or visual object on the display means 17 using a digitized gradation value digitized from a corresponding gradation value; and outputting the generated high-speed drawing display data to the display means 17 when the drawing switching signal is input.

When adopting the display processing program according to the present embodiment, the drawing switching signal is input if high-speed drawing processing such as display scrolling on the display means 17 need to be performed. In response to this input, the high-speed drawing display data is output to the display means 17, and display is performed.

When this high-speed drawing is performed, in case a plurality of pieces of gradation value specific drawing display data, which consists of pixels having with a common gradation value, are used, computations for drawing processing are increased as the number of gradation values rises. Therefore, loads on the CPU and the graphic controller for drawing are increased. In the present embodiment, the high-speed drawing display data for displaying each pixel concerning a character of a visual object using a digitized gradation value digitized from a corresponding gradation value is generated, and display is performed on the display means 17 based on this generated data.

When high-speed drawing is required like this situation, using data digitized from each gradation value (in other words, data having the reduced number of gradation values) enables executing rapid processing without increasing loads on the CPU and the graphic controller. Furthermore, while scrolling and the like requiring high-speed drawing, visibility has been low from the beginning. Therefore, even if each gradation value is reduced and a quality of a character or visual object is thereby slightly decreased, a reduction in visual effect such as appearances or definiteness can be suppressed at minimum.

As explained above, even while high-speed drawing of display data having the plurality of gradation values such as a gray scale, rapid drawing processing can be executed while hardly reducing the visual effect.

The display processing apparatus 25 according to the above described embodiment is characterized in that the high-speed drawing data generating means S120 includes a pixel specific gradation processing means (the step S120) for digitizing pixel specific gradation value data having a gratin value for each pixel that configures a character or visual object by applying a predetermined threshold value for gradation values to generate high-speed drawing display data after a drawing switching signal is input to the drawing switching signal input means S110, and the high-speed drawing data output means S130 outputs the high-speed drawing display data generated by the pixel specific gradation processing means S120 to the display means 17.

The pixel specific gradation processing means S120 digitizes the pixel specific gradation value data with a gradation value for each pixel by applying the threshold value, thereby generating the high-speed drawing display data. Using data having the reduced number of gradations in this manner, it is possible to perform rapid processing without increasing loads on the CPU and the graphic controller.

The display processing apparatus 25 according to the above described embodiment is characterized by comprising: a first regular drawing processing means (the step S140 in FIG. 6 in this example) that generates first regular drawing display data on each gradation value, and which consists of pixels with a common gradation value in the plurality of pixels that configures the character or visual object, and which displays each pixel concerning a character or visual object on the display means 17, while regular drawing with no shift to the high-speed drawing processing; and a first regular drawing data output means (the step S150 in FIG. 6 in this example) for outputting the first regular drawing display data generated by this first regular drawing processing means S140 to the display means 17.

In a regular mode where the processing does not shift to the high-speed drawing processing, the first regular drawing processing means S140 generates the first regular drawing display data on each gradation value, which consists of pixels with a common gradation value in the plurality of pixels that configures the character or visual object while drawing. The first regular drawing data output means S150 outputs the generated first regular drawing display data to the display means 17. With such a structure, decomposing character or visual object data in a gray scale which should be eventually drawn as each first regular drawing display data corresponding to gradations (except the gradation value 0) of the gray scale and executing blend-drawing for the number of times equal to the number of pieces of decomposed data enables executing drawing (even if blend-drawing having blend ratio for each pixel is not performed).

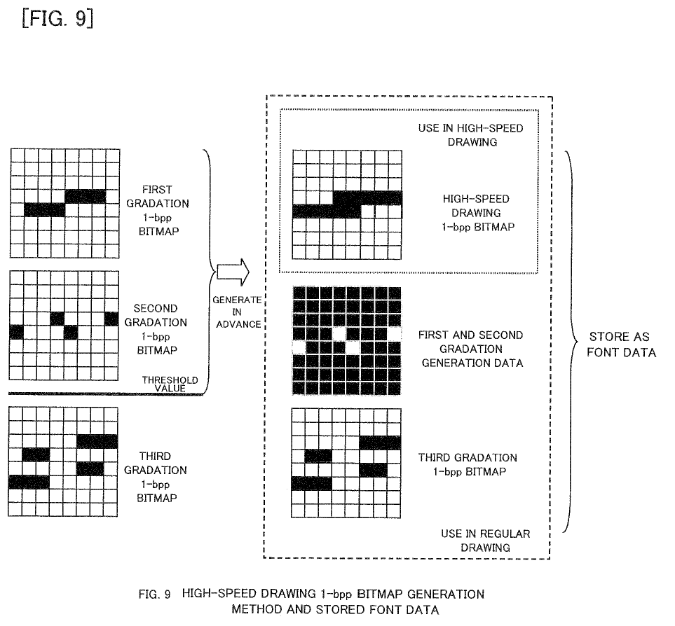

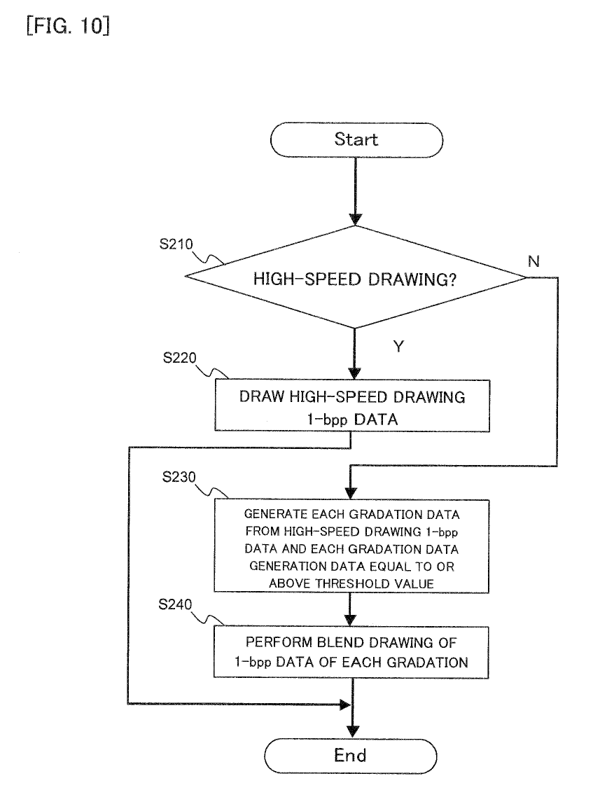

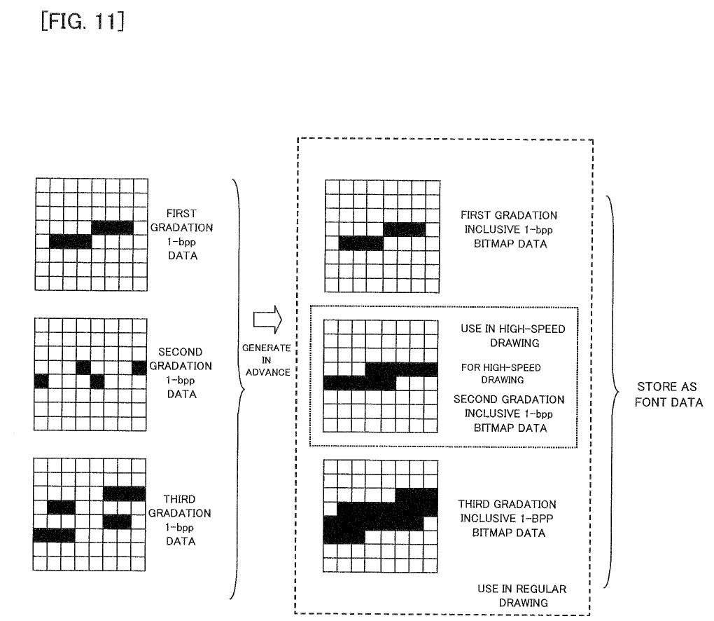

The second embodiment according to the present invention will be explained with reference to FIGS. 9 and 10. The present embodiment is an embodiment in case to prepare the same number of 1-bpp bitmaps formed of pixels with the same blend ratio alone as the number of gradations (except a gradation value 0) of a gray scale, and these pieces of data are used as font data.

Taking display data that consists of 8×8=64 pixels of the first to fourth gradations shown in FIG. 2 in the first embodiment as an example, font data, which is required to draw this display data, is three pieces of data such as 1-bpp bitmap data including pixels of the first gradation with the gradation value 3, 1-bpp bitmap data including pixels of the second gradation having the gradation value 2, and 1-bpp bitmap data including pixels of the third gradation with the gradation value 1, as same as previously explained above in FIG. 7, and these pieces of data are stored in the work memory 15.

Then, in the present embodiment, the graphic controller 14 previously creates 1-bpp bitmap data for high-speed drawing using two pieces of data such as first gradation 1-bpp bitmap data (the gradation value 3) and second gradation 1-bpp bitmap data (the gradation value 2) in the three pieces of 1-bpp bitmap data.

That is, as shown in FIG. 9, a result, which is operated logical disjunction (OR) on 1-bpp bitmap data for a plurality of gradations (the first gradation and the second gradation in this example) with gradation values equal to or above a threshold value (2 in this example), is generated in advance as the 1-bpp bitmap data for high-speed drawing that is pre-rasterized data. Furthermore, at this time, a result, which is operated logical negation (NOT) on the second gradation 1-bpp bitmap data (=1-bpp bitmap data for generation of the first and second gradations), and third gradation 1-bpp bitmap data (the gradation value 1) as one of the above explained three pieces are also generated as pre-rasterized data for regular drawing. These three pieces of previously generated pre-rasterized data are stored in the work memory 15 in advance.

The three pieces of pre-rasterized data are previously generated in this manner. Thereby, while regular drawing, the first gradation 1-bpp bitmap data can be generated by operating logical conjunction (AND) on the high-speed drawing 1-bpp bitmap data shown in an upper column on the right-hand side in FIG. 9 and the 1-bpp bitmap data for generation of the first and second gradations shown in a middle column. Also, the second gradation 1-bpp bitmap data can be generated by operating logical negation (NOT) on the 1-bpp bitmap data for generation of the first and second gradations.

FIG. 10 is a flowchart showing a control procedure for drawing one unit such as one character and so on, which is executed by the graphic controller 14 to carry out the drawing processing explained in FIG. 9. On a side note, this flowchart is started, for instance, when a car navigation apparatus S is started.

In FIG. 10, at first, step S210 is the same as the step S110 in FIG. 6 described in the former first embodiment. That is, for example, scrolling is carried out by an operation through the operating means, and whether a drawing switching signal that is used to shift to high-speed drawing from regular drawing has been input from a system controller 5 (in other words, whether the current mode is a high-speed drawing or not) is determined.

When the drawing switching signal has been input, the determination is satisfied, and the processing advances to step S220. In the step S220, the high-speed drawing 1-bpp bitmap data (referring the upper column on the right-hand side in FIG. 9) stored in the work memory 15 at this point in time is output to a display 17 through a display control part 16 to have drawing, and this flow is terminated.

On the other hand, when the drawing switching signal for shift to high-speed drawing from regular drawing has not been input at the S210, the determination is not satisfied, and the processing proceeds to step S230.

In the step S230, as explained above, the first gradation 1-bpp bitmap data is generated by operating logical conjunction (AND) on the high-speed drawing 1-bpp bitmap data and the 1-bpp bitmap data for generation of the first and second gradations (referring the middle column on the right-hand side in FIG. 9). Also, the second gradation 1-bpp bitmap data is generated by operating logical negation (NOT) on the 1-bpp bitmap data for generation of the first and second gradations.

Afterwards, moving to step S240, the first gradation 1-bpp bitmap data generated in the above described step S140, the above described second gradation 1-bpp bitmap data, and the third gradation 1-bpp bitmap data previously held in the work memory 15, are respectively multiplied by desired blend ratio, thereby it makes to realize a gray scale. Thus, by the data is output to the display 17 through the display control part 16, drawing is performed. A behavior at this time is the same as previously explained with reference to FIG. 8, thereby a detailed explanation is omitted thereof.

When the step S240 is finished, this flow is terminated.

As explained above, the display processing apparatus 25 according to the present embodiment is the display processing apparatus 25 which generates and outputs display data for displaying a character or visual object that consists of a plurality of pixels on the display means (the display 17 in this example) using a predetermined gradation value in accordance with each pixel, and it is characterized by comprising: the drawing switching signal input means (the step S210 in the flow shown in FIG. 10 in this example) for inputting a drawing switching signal for shift to high-speed drawing processing; the high-speed drawing data generating means (corresponding to previously generating 1-bpp bitmap data in the upper column on the right-hand side in FIG. 9 in this example) for generating high-speed drawing display data for displaying each pixel concerning the character or visual object on the display means 17 using a digitized gradation value digitized from each corresponding gradation value; and the high-speed drawing data output means (the step S220 in the flow shown in FIG. 10 in this example) for outputting the high-speed drawing display data generated by the high-speed drawing data generating means to the display means 17 when the drawing switching signal is input by the drawing switching signal input means S210.

In the display processing apparatus 25 according to the present embodiment, for instance, in case to be requested to execute high-speed drawing processing while display scrolling on the display means 17, the drawing switching signal is input through the drawing switching signal input means S210. Thus, the high-speed drawing display data is output to the display means 17 from the high-speed drawing data output means S220 in response to this input, thereby display is performed. In this high-speed drawing, for example, when a plurality of pieces of gradation value specific drawing display data that consists of pixels with a common gradation value, computations for drawing processing are increased as the number of the gradation values rises. Therefore, a load on the graphic controller for drawing is increased. In the present embodiment, the high-speed drawing data generating means generates the high-speed drawing display data that is used to display each pixel corresponding to the character or visual object by utilizing a digitized gradation value digitized from corresponding gradation value, and the generated data is used to perform display on the display means 17.

When the high-speed drawing is required in this manner, using data digitized from each gradation value (in other words, data having the reduced number of gradations) enables rapidly executing processing without increasing a load on the graphic controller. Additionally, while scrolling and the like requiring high-speed drawing, visibility has been low from the beginning. Therefore, even if each gradation value is reduced and a quality of a character or visual object is thereby slightly decreased, a reduction in visual effect such as appearances or definiteness can be suppressed at minimum.

As explained above, even in high-speed drawing of display data with a plurality of gradation values, e.g., a gray scale, the visual effect is hardly reduced, it is possible to execute rapid drawing processing.

In the display processing apparatus 25 according to the above described embodiment, the high-speed drawing data generating means includes the gradation specific pixel processing means (corresponding to previously generating 1-bpp bitmap data in the upper column on the right-hand side in FIG. 9 in this example) that previously generates high-speed drawing display data before a drawing switching signal is input to the drawing switching signal input means S210, based on gradation value specific pixel data that consists of pixels with a common gradation value in a plurality of pixels that configures a character or visual object, and the high-speed drawing data output means S220 outputs the high-speed drawing display data generated by the gradation specific pixel processing means to the display means after the drawing switching signal is input to the drawing switching signal input means S210.

The gradation specific pixel processing means previously generates the high-speed drawing display data based on the gradation value specific pixel data that consists of pixels with a common gradation value in the plurality of pixels (based on a logical formula in this example). As a result, after the drawing switching signal is input, the high-speed drawing data output means S220 can output the high-speed drawing display data having the reduced number of gradations based on the gradation value specific pixel data to the display means 17. Consequently, rapid processing can be executed without increasing loads on the CPU and the graphic controller.

The display processing apparatus 25 according to the above described embodiment is characterized by having the second regular drawing data output means (the step S240 in the flow shown in FIG. 10 in this example) for outputting to the display means 17 second regular drawing display data (“the first gradation 1-bpp bitmap data”, “the second gradation 1-bpp bitmap data”, and “the third gradation 1-bpp bitmap data” shown in the upper, middle, and lower columns on the left-hand side in FIG. 9) which is used to display each pixel concerning a character or visual object on the display means 17 in a regular mode that does not shift to high-speed drawing processing.

It is possible to have drawing by outputting the second regular drawing display data to the display means 17 in the second regular drawing data output means S240 in the regular mode that does not shift to high-speed drawing processing.

The display processing apparatus 25 according to the above described embodiment is characterized by having the second regular drawing processing means (S230 in the flow shown in FIG. 10 in this example) generates second regular drawing display data based on high-speed drawing display data (“the high-speed drawing 1-bpp bitmap data” shown in the upper column on the right-hand side in FIG. 9) while regular drawing with no shift to high-speed drawing processing.

In the regular mode that does not shift to high-speed drawing processing, the second regular drawing processing means S230 generates the second regular drawing display data, based on the high-speed drawing display data created in accordance with gradation specific pixel data by the gradation specific pixel processing means in advance while drawing. The second regular drawing data output means S240 outputs the generated second regular drawing display data to the display means 17. By using the high-speed drawing display data already generated while regular drawing in this manner, it is possible to have drawing character or visual object data of a gray scale, which should be finally drawn only thorough a simple arithmetic processing (without blend-drawing having blend ratio for each pixel).

The third embodiment according to the present invention will be explained with reference to FIGS. 11 to 13. The present embodiment is an embodiment when the second embodiment is further developed to increase speed of drawing processing.

Like the above description, display data that consists of 8×8=64 pixels of the first to fourth gradations shown in FIG. 2 will be taken as an example. In this case, font data required to draw this display data is likewise three pieces of data, i.e., first gradation 1-bpp bitmap data (a gradation value 3), second gradation 1-bpp bitmap data (a gradation value 2), and third gradation 1-bpp bitmap data (a gradation value 1) in the present embodiment, and these pieces of data are stored in a work memory 15.

Thus, in the present embodiment, a graphic controller 14 uses the three pieces of data, the first gradation 1-bpp bitmap data (the gradation value 3), the second gradation 1-bpp bitmap data (the gradation value 2), and the third gradation 1-bpp bitmap data (the gradation value 1) to generate all pieces of 1-bpp bitmap data having gradation value equal to above gradation value of the respective gradations (gradation value inclusive pixel data) as pre-rasterized data in advance. That is, in this example, as shown in FIG. 11, three pieces of data, i.e., “first gradation 1-bpp bitmap data having a gradation value (=3) equal to or above a gradation value of a first gradation (first gradation inclusive 1-bpp bitmap data)”, “first and second gradation 1-bpp bitmap data having gradation values (=2, 3) equal to above a gradation value of a second gradation (second gradation inclusive 1-bpp bitmap data)”, and “first, second, and third gradation 1-bpp bitmap data having gradation values (=1, 2, 3) equal to or above a gradation value of a third gradation (third gradation inclusive 1-bpp bitmap data)” are generated. Of these pieces of data, “the first and second gradation 1-bpp bitmap data” is generated as high-speed drawing 1-bpp bitmap data, and the respective pieces of data are stored in the work memory 15.

On a side note, “the first and second gradation 1-bpp bitmap data having gradation values equal to or above the gradation value of the second gradation (the second gradation inclusive 1-bpp bitmap data)” is referred to as the second gradation inclusive 1-bpp bitmap data in the sense that data having gradation values (=2, 3) equal to above the gradation value of the second gradation, i.e., both data having the gradation value 2 of the second gradation and data having the gradation value 3 of the first gradation are included in a comprehensive manner like the above description. However, in this case, this data is substantially equal to “the high-speed drawing 1-bpp bitmap data” shown in the upper column on the right-hand side in FIG. 9.

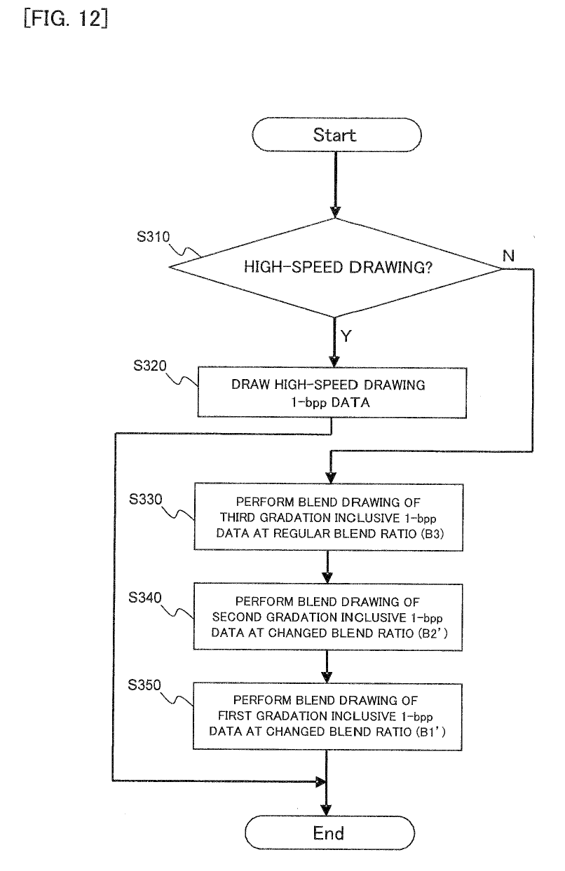

FIG. 12 is a flowchart that is executed by the graphic controller 14 to carry out the above-described drawing processing and shows a control procedure for drawing one unit such as one character and so on. On a side note, this flow chart is started, for instance, when a car navigation apparatus S is activated.

In FIG. 12, at first, in step S310 the same procedure as the step S110 shown in FIG. 6 or the step S210 shown in FIG. 10 in the first and the second embodiments is performed. That is, for example, scrolling is carried out through an operation by operating means, and whether a drawing switching signal required to shift from regular drawing to high-speed drawing has been input from a system controller 5 in response to this operation (in other words, whether the current mode is a high-speed drawing mode or not) is determined.

If the drawing switching signal has been input, the determination is satisfied, and the processing advances to step S320. In the step S320, the same procedure as the step S220 in FIG. 10 is performed. That is, the high-speed drawing 1-bpp bitmap data stored in the work memory 15 at this point in time (referring a middle column on the right-hand side in FIG. 11) is output to a display 17 through a display control part 16 to have drawing, and this flow is terminated.

On the other hand, if the drawing switching signal to shift high-speed drawing from regular drawing has not been input in the step S310, the determination is not satisfied, thereby moving to step S330.

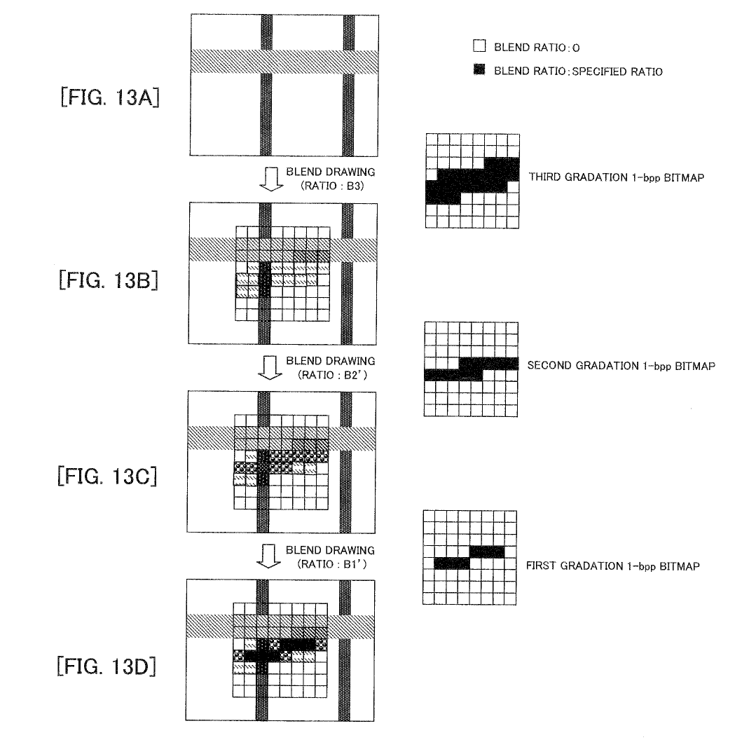

In the step S330, the third gradation inclusive 1-bpp bitmap data (=equal to the result through operating logical disjunction on the first gradation 1-bpp bitmap data, the second gradation 1-bpp bitmap data, and the third gradation 1-bpp bitmap data) previously held in the work memory 15 as explained above is multiplied by a regular blend ratio (B3) for the third gradation, thereby realizing a gray scale. Thus, this data is output to the display 17 via the display control part 16, drawing is held. FIGS. 13A to 13D are explanatory drawings showing subsequent blend-drawing behaviors, and FIG. 13B is correspond to this step S330.

Afterwards, moving to step S340, the second gradation inclusive 1-bpp bitmap data (=equal to the result through operating logical disjunction on the first gradation 1-bpp bitmap data and the second gradation 1-bpp bitmap data) previously held in the work memory 15 is multiplied by blend ratio (B2′) changed through the above described B3 and a regular blend ratio (B2) for the second gradation (B2), thereby realizing a gray scale. Thus, this data is output to the display 17 via the display control part 16, thereby drawing is held (referring FIG. 13C).

Afterwards, moving to step S350, the first gradation inclusive 1-bpp bitmap data (=equal to the first gradation 1-bpp bitmap data itself in this example) previously held in the work memory 15 as explained above is multiplied by a blend radio (B1′) changed through the above described B2′ and a regular blend ratio for the first gradation (B), thereby gray-scaling the data. Additionally, this data is output to the display 17 via the display control part 16, thus drawing is held (referring FIG. 13D).

When the step S350 is finished, this flow is terminated.

On a side note, by appropriately adjusting the blend ratio at each of the step S330, the step S340, and the step S350 (without calculating for generation of data on each gradation), it is possible to obtain a desired image in the present embodiment, thereby to have further high-speed performance. The blend ratio on this condition can be calculated as follows, for example.

That is, assuming a color of a pixel of gradation n before drawing is Cdₙ, blend ratio of the gradation n is Bₙ, a color of a pixel of gradation n−1 (a higher order of n) before drawing the gradation n is Cdₙ₋₁, and blend ratio is Bₙ₋₁, a character drawing color is Cs, and a color of a pixel before drawing a character is Cd, a pixel of the arbitrary gradation n must have a color represented by the following computational expression.

Cdₙ=Cd(1−Bₙ)+Cs·Bₙ, (a pixel of the gradation n) (Expression 1)

Here, drawing of nth gradation inclusive 1-bpp data of the lowest gradation N (N=3 in this example) shown in FIG. 13 is performed based on the following computational expression.

Cd_{N}=Cd(1−B_{N})+Cs·B_{N} (a pixel of “1”)

Cd_{N}=Cd (a pixel of “0”) (Expression 3)

Next, drawing of a gradation N−1 will be considered. In this case, the N gradation inclusive 1-bpp bitmap data required to draw the gradation N includes a pixel of a gradation N−1. Therefore, on a stage of drawing the gradation N−1, blending has been already performed at blend ratio BN in drawing of the gradation N. Therefore, in drawing of the inclusive 1-bpp data for the next gradation of the lowest gradation N, i.e., the N−1th gradation, the blend ratio must be adjusted (B_{N-1}′). This blend-drawing is performed based on the following computational expression.

Cd_{N-1}=Cd_{N}(1−B_{N-1}′)+Cs·B_{N-1}′(a pixel of “1”)

Cd_{N-1}=Cd_{N} (pixel of “0”) (Expression 4)

On a side note, B_{N-1}′ is calculated in the following manner.

Based on (Expression 3) and (Expression 4),

Cd_{N-1}={Cd(1−B_{N})+Cs·B_{N}}(1−B_{N-1}′)+Cs·B_{N-1}′(a pixel of the N−1 gradation inclusive 1-bpp data) (Expression 5)

Also, based on (Expression 1),

Cd_{N-1}′=Cd(1-B_{N-1})+Cs·B_{N-1} (Expression 6)

Based on (Expression 5) and (Expression 6),

B_{N-1}′=(B_{N-1}−B_{N})/(1−B) (Expression 7)

That is, even if the pixel of the gradation N−1 has been already subjected to blend-drawing in drawing of the gradation N, it can be understood that subjecting the N−1th gradation inclusive 1-bpp data to blend-drawing at B_{N-1}′ calculated in (Expression 7) enables obtaining a drawing result at a desired blend ratio (B_{N}).

Next, the arbitrary gradation n−1 will be considered. Since data of the arbitrary gradation n−1 includes a pixel of the gradation n as explained above, it has been already blended at the blend ratio B_{N} in drawing of the gradation n on a stage where drawing of the gradation n−1 is performed. Therefore, in regard to drawing the inclusive 1-bpp data for the arbitrary n−1th gradation, the blend ratio must be adjusted (Bₙ₋₁′). Blend-drawing is carried out based on the following computational expression.

Cdₙ₋₁=Cdₙ(1−Bₙ₋₁′)+Cs·Bₙ₋₁′(a pixel of “1” in the n−1th gradation inclusive 1-bpp data)

Cdₙ₋₁=Cdₙ (a pixel of “0”) (Expression 8)

On a side note, Bₙ₋₁′ is calculated in the following manner.

Based on (Expression 1),

Cdₙ=Cd(1−Bₙ)+Cs·Bₙ, (a pixel of the gradation n) (Expression 9)

### Based on (Expression 8) and (Expression 9),

Cdₙ₋₁={Cd(1−Bₙ)+Cs·Bₙ}(1−Bₙ₋₁′)+Cs·B_{n-1′} (Expression 10)

Also, based on (Expression 1),

Cdₙ₋₁=Cd(1−Bₙ)+Cs·Bₙ₋₁ (a pixel of the gradation n) (Expression 11)

### Based on (Expression 10) and (Expression 11),

Bₙ₋₁′=(Bₙ₋₁−Bₙ)/(1−Bₙ) (Expression 12)

As explained above, it can be understood that subjecting the n−1th gradation inclusive 1-bpp data to blend-drawing at Bₙ₋₁′ calculated based on (Expression 12) enables obtaining a drawing result at the desired blend ratio (Bₙ) even if the pixel of the gradation n−1 has been already subjected to blend-drawing in drawing of the gradation n.

As explained above, the display processing apparatus 25 according to the present embodiment is the display processing apparatus 25 that generates and outputs display data for displaying a character or visual object that consists of a plurality of pixels on the display means (the display 17 in this example) using a predetermined gradation value in accordance with each pixel, and it is characterized by comprising: the drawing switching signal input means (the step S310 in the flow shown in FIG. 12 in this example) for inputting a drawing switching signal for shift to high-speed drawing processing; the high-speed drawing data generating means (corresponding to previously generating the 1-bpp bitmap data in the middle column on the right-hand side in FIG. 12 in this example) for generating high-speed drawing display data for displaying on the display means 17 each pixel concerning the character or visual object using a digitized gradation value digitized from a corresponding gradation value; and the high-speed drawing data output means (the step S320 in the flow shown in FIG. 12 in this example) for outputting the high-speed drawing display data generated by the high-speed drawing data generating means to the display means 17 when the drawing switching signal is input by the drawing switching signal input means S310.

In the display processing apparatus 25 according to the present embodiment, when high-speed drawing processing, e.g., display scrolling on the display means 17 needs to be executed, the drawing switching signal is input by the drawing switching signal input means S310. In response to this input, the high-speed drawing display data is output to the display means 17 from the high-speed drawing data output means S320, thus effecting display. When this high-speed drawing is performed, in case a plurality of pieces of gradation value specific drawing display data that consists of pixels having, e.g., a common gradation value are used, computations for drawing processing are increased as the number of gradation values rises. Therefore, a load on the graphic controller for drawing is increased. In the present embodiment, the high-speed drawing data generating means generates the high-speed drawing display data for displaying each pixel concerning the character of the visual object using each digitized gradation value digitized from a corresponding gradation value, and the generated data is used to display on the display means 17.

When high-speed drawing is required in this manner, data digitized from each gradation value (in order words, data having the reduced number of gradations) is used. As a result, rapid processing can be executed without increasing a load imposed on the graphic controller. Furthermore, in scrolling and the like requiring high-speed drawing, since visibility is lower from the beginning, a reduction in visual effect, e.g., appearances or definiteness can be suppressed at minimum even if each gradation value is reduced and a quality of a character of a visual object is thereby slightly decreased.

As explained above, even in high-speed drawing of display data having a plurality of gradation values, e.g., a gray scale, rapid drawing processing can be executed while hardly lowering the visual effect.

The display processing apparatus 25 in the above described embodiment is wherein the high-speed drawing data generating means includes the gradation specific pixel processing means (corresponding to previously generating the second gradation inclusive 1-bpp bitmap data in the middle column on the right-hand side in FIG. 11 in this example) for previously generating high-speed drawing display data based on gradation value specific pixel data that consists of pixels with a common gradation value in a plurality of pixels that configures a character or visual object before the drawing switching signal is input to the drawing switching signal input means S310, and the high-speed drawing data output means S320 outputs the high-speed drawing display data generated by the gradation specific pixel processing means to the display means 17 after the drawing switching signal is input to the drawing switching signal input means S310.

The gradation specific pixel processing means previously generates the high-speed drawing display data based on the gradation value specific pixel data that consists of pixels with a common gradation value in the plurality of pixels. As a result, after the drawing switching signal is input, the high-speed drawing data output means S320 can output the high-speed drawing display data having a reduced number of gradations based on the gradation value specific pixel data to the display means 17. Consequently, rapid processing can be executed without increasing loads on the CPU and the graphic controller.

The display processing apparatus 25 according to the above described embodiment is characterized by comprising the second regular drawing data output means (the step S330, the step S340, and the step S350 in the flow shown in FIG. 12 in this example) for outputting to the display means 17 second regular drawing display data (“the first gradation inclusive 1-bpp bitmap data”, “the second gradation inclusive 1-bpp bitmap data”, and “the third gradation inclusive 1-bpp bitmap data” shown in the upper, middle, and lower columns on the right-band side in FIG. 11) that is used to display each pixel concerning a character or visual object on the display means 17 in a regular mode that does not shift to high-speed drawing processing.

In the regular mode that does not shift to high-speed drawing processing, when the second regular drawing data output means S330, S340, and S350 output the second regular drawing display data to the display means 17, drawing can be performed.

The display processing apparatus 25 according to the above described embodiment is characterized in that the gradation specific pixel processing means generates high-speed gradation value pixel data (“the second gradation inclusive 1-bpp bitmap data” in the middle column on the right-hand side in FIG. 11) that consists of pixels with gradation values equal to or above a predetermined gradation value as high-speed drawing display data, based on gradation value specific pixel data (“the first gradation 1-bpp bitmap data”, “the second gradation 1-bpp bitmap data”, and “the third gradation 1-bpp bitmap data” shown in the upper, middle, and lower columns on the left-hand side in FIG. 11).

The gradation specific pixel processing means previously generates the high-speed gradation value pixel data that consists of pixels with gradation values equal to or above the predetermined gradation value as the high-speed drawing display data based on the gradation value specific pixel data that consists of pixels with a common gradation value in the plurality of pixels. As a result, after the drawing switching signal is input, the high-speed drawing data output means can output high-speed drawing display data having the reduced number of gradations based on the high-speed gradation value pixel data to the display means 17. Consequently, rapid processing can be executed without increasing loads on the CPU and the graphic controller.

The display processing apparatus 25 according to the above described embodiment is characterized in that the gradation specific pixel processing means generates, except for the high-speed drawing display data, regular mode gradation value pixel data (“the first gradation inclusive 1-bpp bitmap data”, “the second gradation inclusive 1-bpp bitmap data”, and “the third gradation inclusive 1-bpp bitmap data” shown in the upper, middle, and lower columns on the right-hand side in FIG. 11), which consists of pixels with gradation values equal to or above a predetermined gradation value, and is used in a regular mode that does not shift to high-speed drawing processing, based on gradation value specific pixel data besides high-speed drawing display data, and the second regular drawing data output means S330, S340, and S350 output data, which are blended the high-speed and regular mode gradation value pixel data together in a desirable condition, to the display means 17 as second regular drawing display data.

In the present embodiment, the gradation specific pixel processing means previously generates the regular mode gradation value pixel data that consists of pixels having pixel values equal to or above the predetermined gradation value based on the gradation value specific pixel data. Thus, in the regular mode that does not shift to high-speed drawing processing, while drawing, the second regular drawing data output means S330, S340, and S350 blend the regular mode gradation value pixel data (“the first gradation inclusive 1-bpp bitmap data” and “the third gradation inclusive 1-bpp bitmap data” in the upper column and the lower column on the right hand side in FIG. 11) previously created in accordance with the gradation specific pixel data by the gradation specific pixel processing means and the high-speed gradation value pixel data (“the second gradation inclusive 1-bpp bitmap data” in the middle column on the right-hand side in FIG. 11) in a desirable condition, and output obtained data to the display means 17. In this manner, the regular mode gradation value pixel data already created in regular drawing and the high-speed gradation value pixel data are blended to be used. As a result, character of visual object data of a gray scale which should be eventually drawn can be rapidly drawn by blend processing alone without creating new data.

The display processing apparatus 25 according to the first embodiment is the display processing apparatus 25 that generates and outputs display data for displaying a character or visual object that consists of a plurality of pixels to the display 17 using a predetermined gradation value in accordance with each pixel, comprises: the step S110 of inputting a drawing switching signal for shift to high-speed drawing processing; the step S120 of generating high-speed drawing display data which is used to display each pixel concerning the character or visual object in the display 17 using a digitized gradation value digitized from a corresponding gradation value; and the step S130 of outputting high-speed drawing display data generated in the step S120 to the display 17 when the drawing switching signal is input in the step S110.

In the display processing apparatus 25 according to the first embodiment, for example, in case it is necessary to have high-speed drawing processing such as display scrolling and the like on the display 17, the drawing switching signal is input in the step S110. Thus, in response to this input, the high-speed drawing display data is output to the display 17 from the step S130, thereby display is performed. While this high-speed drawing, for instance, in case a plurality of pieces of gradation value specific drawing display data that consists of pixels having, e.g., a common gradation value are used, computations for drawing processing are increased as the number of gradation values rises. Therefore, a load imposed on the graphic controller for drawing is increased. In this first embodiment, in the step S120, the high-speed drawing display data that is used to display each pixel concerning the character or visual object using a digitized gradation value digitized from each corresponding gradation value is generated, and this generated data is utilized to display in the display 17.

When high-speed drawing is required in this manner, data digitized from each gradation value (in other words, data having the reduced number of gradations) is used. As a result, it is possible to have rapid processing without increasing a load on the graphic controller. Also, while scrolling and the like requiring high-speed drawing, since visibility has been low from the beginning, a reduction in visual effect, e.g., appearances or definiteness can be suppressed at minimum even if each gradation value is reduced and a quality of a character or visual object is thereby slightly decreased.

The display processing apparatus 25 according to the second embodiment is the display processing apparatus 25 that generates and outputs display data for displaying a character or visual object that consists of a plurality of pixels in the display 17 using a predetermined gradation value in accordance with each pixel, comprises: the step S210 of inputting a drawing switching signal for shift to high-speed drawing processing; the high-speed drawing data generating means that generates high-speed drawing display data for displaying each pixel concerning the character or visual object in the display 17 using a digitized gradation value digitized from each corresponding gradation value; and the step S220 of outputting the high-speed drawing display data generated by the high-speed drawing data generating means to the display 17 when the drawing switching signal is input in the step S210.

In the display processing apparatus 25 according to the second embodiment, for example, while high-speed drawing processing, e.g., display scrolling in the display 17 needs to be executed, the drawing switching signal is input in the step S210. In response to this input, the high-speed drawing display data is output to the display 17 from the step S220, thereby effecting display. When this high-speed drawing is performed, in case a plurality of pieces of gradation value specific drawing display data that consists of pixels having, e.g., a common gradation value are used, computations for drawing processing are increased as the number of gradation values rises. Therefore, a load imposed on the graphic controller for drawing is increased. In this second embodiment, the high-speed drawing data generating means generates the high-speed drawing display data for displaying each pixel concerning the character or visual object using each digitized gradation value digitized from each corresponding gradation value, and this generated data is utilized to display on the display 17.

When high-speed drawing is required in this manner, using data digitized from each gradation value (in other words, data having the reduced number of gradations) enables executing rapid processing without increasing a load imposed on the graphic controller. Moreover, while scrolling and the like requiring high-speed drawing, since visibility is low from the beginning, a reduction in visual effect, e.g., appearances or definiteness can be suppressed at minimum even if each gradation value is reduced and a quality of a character or visual object is thereby slightly decreased.

The display processing apparatus 25 according to the third embodiment is the display processing apparatus 25 that generates and outputs display data for displaying a character or visual object that consists of a plurality of pixels in the display 17 using a predetermined gradation value in accordance with each pixel, comprises: the step S310 of inputting a drawing switching signal for shift to high-speed drawing processing; the high-speed drawing data generating means that generates high-speed drawing display data for displaying each pixel concerning the character or visual object in the display 17 using each digitized gradation value digitized from each corresponding gradation value; and the step S320 of outputting the high-speed drawing display data generated by the high-speed drawing data generating means to the display 17 when the drawing switching signal is input in the step S310.

In the display processing apparatus 25 according to the third embodiment, for example, when high-speed drawing processing, e.g., display scrolling in the display 17 needs to be executed, the drawing switching signal is input in the step S310. In response to this input, the high-speed drawing display data is output to the display 17 from the step S320, thereby effecting display. When this high-speed drawing is performed, in case a plurality of pieces of gradation value specific drawing display data that consists of pixels having, e.g., a common gradation value are used, computations for drawing processing are increased as the number of gradation values rises. Therefore, a load on the graphic controller for drawing is increased. In this third embodiment, the high-speed drawing data generating means generates the high-speed drawing display data for displaying each pixel concerning the character or visual object using each digitized gradation value digitized from each corresponding gradation value, and this generated data is utilized to display on the display 17.

When high-speed drawing is required in this manner data digitized from each gradation value (in other words, data having the reduced number of gradations) is used. As a result, rapid processing can be executed without increasing a load imposed on the graphic controller. Additionally, while scrolling and the like requiring high-speed drawing, since visibility is low from the beginning, a reduction in visual effect, e.g., appearances or definiteness can be suppressed at minimum even if each gradation value is reduced and a quality of a character or visual object is thereby slightly decreased.

1-10. (canceled)

11. A display processing apparatus generates and outputs display data for displaying a character or visual object that consists of a plurality of pixels on a display unit using a predetermined gradation value in accordance with each pixel, comprising:
a drawing switching signal input unit that inputs a drawing switching signal for shift to high-speed drawing processing;
a high-speed drawing data generating unit that generates high-speed drawing display data for displaying each pixel concerning said character or visual object on said display unit using a digitized gradation value digitized from said corresponding gradation value;
a high-speed drawing data output unit that outputs said high-speed drawing display data generated by said high-speed drawing data generating unit to said display unit when said drawing switching signal is input by said drawing switching signal input unit;
a first regular drawing processing unit that generates first regular drawing display data on each gradation value, which consists of pixels with a common gradation value in said plurality of pixels that configures said character or visual object, which displays each pixel concerning said character or visual object on said display unit, while regular drawing with no shift to said high-speed drawing processing; and
a first regular drawing data output unit that outputs said first regular drawing display data generated by said first regular drawing processing unit to said display unit, wherein
said high-speed drawing data generating unit comprises a pixel specific gradation processing unit that digitizes pixel specific gradation value data having a gradation value in accordance with each pixel that configures said character or visual object by applying a predetermined threshold value of said gradation values to generate said high-speed drawing display data after said drawing switching signal is input to said drawing switching signal input unit, and
said high-speed drawing data output unit outputs said high-speed drawing display data generated by said pixel specific gradation processing unit to said display unit.

12. A display processing apparatus generates and outputs display data for displaying a character or visual object that consists of a plurality of pixels on a display unit using a predetermined gradation value in accordance with each pixel, comprising:
a drawing switching signal input unit that inputs a drawing switching signal for shift to high-speed drawing processing;
a high-speed drawing data generating unit that generates high-speed drawing display data for displaying each pixel concerning said character or visual object on said display unit using a digitized gradation value digitized from said corresponding gradation value; and
a high-speed drawing data output unit that outputs said high-speed drawing display data generated by said high-speed drawing data generating unit to said display unit when said drawing switching signal is input by said drawing switching signal input unit, wherein
said high-speed drawing data generating unit comprises:
a gradation specific pixel processing unit that previously generates said high-speed drawing display data before said drawing switching signal is input to said drawing switching signal input unit, based on gradation value specific pixel data that consists of pixels including a common gradation value in said plurality of pixels that configures said character or visual object, and
said high-speed drawing data output unit outputs said high-speed drawing display data generated by said gradation specific pixel processing unit to said display unit after said drawing switching signal is input to said drawing switching signal input unit.

13. The display processing apparatus according to claim 12, wherein
said apparatus further comprises a second regular drawing data output unit that outputs to said display unit second regular drawing display data for displaying each pixel concerning said character or visual object on said display unit in a regular mode that has no shift to said high-speed drawing processing.

14. The display processing apparatus according to claim 13, further comprising:
a second regular drawing processing unit that generates said second regular drawing display data based on said high-speed drawing display data while regular drawing with no shift to said high-speed drawing processing.

15. The display processing apparatus according to claim 12, wherein
said gradation specific pixel processing unit generates high-speed gradation value pixel data that consists of pixels with gradation values equal to or above a predetermined gradation value based on said gradation value specific pixel data as said high-speed drawing display data.

16. The display processing apparatus according to claim 15, wherein
said gradation specific pixel processing unit generates, except for said high-speed drawing display data, regular mode gradation value pixel data, which consists of pixels with gradation values equal to or above a predetermined gradation value, and is used in a regular mode that has no shift to said high-speed drawing processing, based on said gradation value specific pixel data; and
said second regular drawing data output unit outputs data, which is blended said high-speed and regular mode gradation value pixel data together in a desirable condition, to said display unit as said second regular drawing display data.

17. A display processing method for generating and outputting display data for displaying a character or visual object that consists of a plurality of pixels on a display unit using a predetermined gradation value in accordance with each pixel, comprising:
a drawing switching signal input step for inputting a drawing switching signal for shift to high-speed drawing processing;
a high-speed drawing data generation step for generating high-speed drawing display data for displaying each pixel concerning said character or visual object on said display unit using a digitized gradation value digitized from said corresponding gradation value;
a high-speed drawing data output step for outputting said generated high-speed drawing display data to said display unit when said drawing switching signal is input;
a first regular drawing processing step for generating gradation value specific first regular drawing display data which is used to display each pixel concerning said character or visual object on said display unit and consists of pixels with a common gradation value in said plurality of pixels that configures said character or visual object, while regular drawing without shift to said high-speed drawing processing; and
a first regular drawing data output step for outputting said first regular drawing display data generated at said first regular drawing processing step to said display unit,
wherein said high-speed drawing data generation step comprises a pixel specific gradation processing step for digitizing pixel specific gradation value data having a gradation value in accordance with each pixel that configures said character or visual object by applying a predetermined threshold-value of said gradation values to generate said high-speed drawing display data after said drawing switching signal is input at said drawing switching signal input step, and
said high-speed drawing display data generated at said pixel specific gradation processing step is output to said display unit at said high-speed drawing data output step.

18. A display processing method for generating and outputting display data for displaying a character or visual object that consists of a plurality of pixels on a display unit using a predetermined gradation value in accordance with each pixel, comprising:
a drawing switching signal input step for inputting a drawing switching signal for shift to high-speed drawing processing;
a high-speed drawing data generation step for generating high-speed drawing display data for displaying each pixel concerning said character or visual object on said display unit using a digitized gradation value digitized from said corresponding gradation value; and
a high-speed drawing data output step for outputting said generated high-speed drawing display data to said display unit when said drawing switching signal is input, wherein
said high-speed drawing data generation step comprises a gradation specific pixel processing step for previously generating said high-speed drawing display data based on gradation value specific pixel data that consists of pixels with a common gradation value in said plurality of pixels that configures said character or visual object before said drawing switching signal is input at said drawing switching signal input step, and
said high-speed drawing display data generated at said gradation specific pixel processing step is output to said display unit at said high-speed drawing data output step after said drawing switching signal is input at said drawing switching signal input step.

19. A display processing program for allowing a computation unit provided in a display processing apparatus which generates and outputs display data for displaying a character or visual object that consists of a plurality of pixels on a display unit using a predetermined gradation value in accordance with each pixel to execute:
a drawing switching signal input step for inputting a drawing switching signal for shift to high-speed drawing;
a high-speed drawing display data generation step for generating high-speed drawing display data for displaying each pixel concerning said character or visual object on said display unit using a digitized gradation value digitized from said corresponding gradation value;
a high-speed drawing data output step for outputting said generated high-speed drawing display data to said display unit when said drawing switching signal is input;
a high-speed drawing data output step for outputting said generated high-speed drawing display data to said display unit when said drawing switching signal is input;
a first regular drawing processing step for generating gradation value specific first regular drawing display data which is used to display each pixel concerning said character or visual object on said display unit and consists of pixels with a common gradation value in said plurality of pixels that configures said character or visual object, while regular drawing without shift to said high-speed drawing processing; and
a first regular drawing data output step for outputting said first regular drawing display data generated at said first regular drawing processing step to said display unit, wherein
said high-speed drawing data generation step comprises a pixel specific gradation processing step for digitizing pixel specific gradation value data having a gradation value in accordance with each pixel that configures said character or visual object by applying a predetermined threshold value of said gradation values to generate said high-speed drawing display data after said drawing switching signal is input at said drawing switching signal input step, and
said high-speed drawing display data generated at said pixel specific gradation processing step is output to said display unit at said high-speed drawing data output step.

20. A display processing program for allowing a computation unit provided in a display processing apparatus which generates and outputs display data for displaying a character or visual object that consists of a plurality of pixels on a display unit using a predetermined gradation value in accordance with each pixel to execute:
a drawing switching signal input step for inputting a drawing switching signal for shift to high-speed drawing;
a high-speed drawing display data generation step for generating high-speed drawing display data for displaying each pixel concerning said character or visual object on said display unit using a digitized gradation value digitized from said corresponding gradation value; and
a high-speed drawing data output step for outputting said generated high-speed drawing display data to said display unit when said drawing switching signal is input, wherein
said high-speed drawing data generation step comprises a gradation specific pixel processing step for previously generating said high-speed drawing display data based on gradation value specific pixel data that consists of pixels with a common gradation value in said plurality of pixels that configures said character and said visual object before said drawing switching signal is input at said drawing switching signal input step, and
said high-speed drawing display data generated at said gradation specific pixel processing step is output to said display unit at said high-speed drawing data output step after said drawing switching signal is input at said drawing switching signal input step.
